(19) United States
(12) Patent Application Publication
(10) Pub. No.: US 2019/0383325 A1
(43) Pub. Date: Dec. 19, 2019

(54) PRELOAD JUDGEMENT DEVICE AND PRELOAD JUDGEMENT METHOD

(71) Applicant: FANUC CORPORATION, Yamanashi (JP)

(72) Inventor: Taku Oohara, Yamanashi-ken (JP)

(73) Assignee: FANUC CORPORATION, Yamanashi (JP)

(21) Appl. No.: 16/434,450

(22) Filed: Jun. 7, 2019

(30) Foreign Application Priority Data
Jun. 14, 2018 (JP) 2018-113572

(51) Int. Cl. F16C 19/52; G01L 5/00

(52) U.S. Cl. CPC F16C 19/522; G01L 5/0009

(57) ABSTRACT

A preload judgement device includes: a preload obtaining unit configured to obtain a preload that acts on a bearing that pivotally supports a drive shaft of a motor; and a notification unit configured to give notification that the preload is not appropriate when the obtained preload is not in a set range.

### CROSS-REFERENCE TO RELATED APPLICATION

This application is based upon and claims the benefit of priority from Japanese Patent Application No. 2018-113572 filed on Jun. 14, 2018, the contents of which are incorporated herein by reference.

### BACKGROUND OF THE INVENTION

### Field of the Invention

The present invention relates to a preload judgement device and a preload judgement method for judging whether a preload, acting on a bearing that pivotally supports a drive shaft of a motor, is appropriate.

### Description of the Related Art

Japanese Laid-Open Patent Publication No. 05-069202 discloses a main shaft driving motor having a rear main shaft to which a rotor is attached.

### SUMMARY OF THE INVENTION

In the main shaft driving motor of the technique of Japanese Laid-Open Patent Publication No. 05-069202, the rear main shaft is pivotally supported by a bearing. When a preload acting on the bearing in the axial direction is lower than a set range, the bearing may be damaged.

The resent invention has been made in order to solve the problem above, and an object of the present invention is to provide a preload judgement device and a preload judgement method that are capable of giving notification when a preload acting on a bearing is not in a set range.

A preload judgement device according to a first aspect of the present invention includes: a preload obtaining unit configured to obtain a preload that acts on a bearing that pivotally supports a drive shaft of a motor; and a notification unit configured to give notification that the preload is not appropriate when the obtained preload is not in a set range.

A preload judgement method according to a second aspect of the present invention includes: a preload obtaining step of obtaining a preload that acts on a bearing that pivotally supports a drive shaft of a motor; and a notification step of controlling a notification unit to give notification that the preload is not appropriate when the obtained preload is not in a set range.

According to the present invention, it is possible to give notification when the preload acting on the bearing is not in the set range.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a partial cross sectional view showing a portion where a drive shaft of a motor and a spindle are connected to each other;

FIG. 2 is a cross sectional view showing a configuration of the motor;

FIG. 3 is a block diagram showing the configuration of a preload judgement device; and

FIG. 4 is a flowchart showing the flow of a preload judgement process performed in a control unit.

### DESCRIPTION OF THE PREFERRED EMBODIMENTS

### First Embodiment

### Configuration of Connection Between Motor Drive Shaft and Spindle

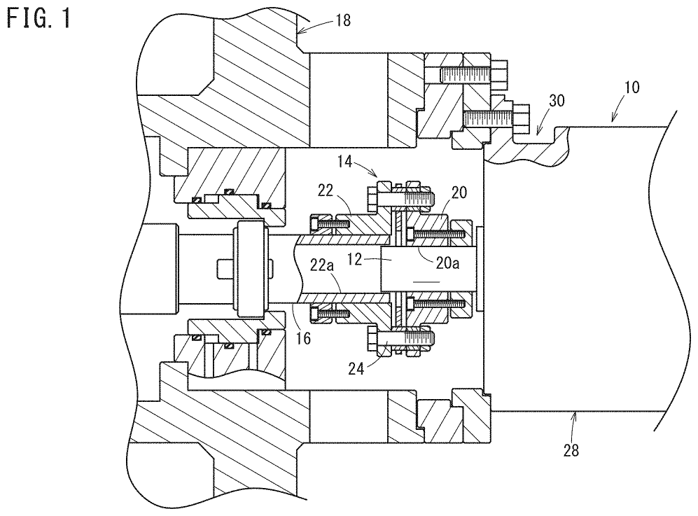

A motor 10 of this embodiment is used for a machine tool, and a spindle 16 is connected to a drive shaft 12 of the motor 10 through a coupling 14. FIG. 1 is a partial cross sectional view showing a portion where the drive shaft 12 of the motor 10 and the spindle 16 are connected to each other. The motor 10 is fixed to a coupling box 18. The drive shaft 12 and the spindle 16 are connected to each other within the coupling box 18.

The coupling 14 includes a first hub 20 and a second hub 22. The drive shaft 12 is inserted in an insertion hole 20a formed in the first hub 20 and rotates integrally with the first hub 20. The spindle 16 is inserted in an insertion hole 22a formed in the second hub 22 and rotates integrally with the second hub 22. The first hub 20 and the second hub 22 are fastened together by bolts 24, and the drive shaft 12 and the spindle 16 are connected to each other.

### Configuration of Motor

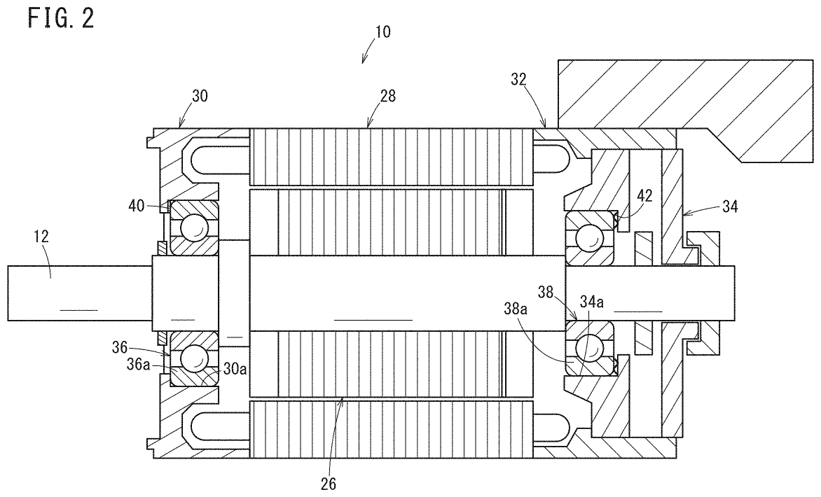

FIG. 2 is a cross sectional view showing a configuration of the motor 10. The motor 10 includes the drive shaft 12, a rotor 26, a stator 28, a front housing 30, a rear housing 32, a rear cover 34, a front bearing 36, and a rear bearing 38.

The rotor 26 is fixed to the drive shaft 12 and rotates integrally with the drive shaft 12. The stator 28 is provided around a circumference of the rotor 26, and both ends of the stator 28 in the axial direction are supported respectively by the front housing 30 and the rear housing 32. The rear housing 32 has a through hole in the axial direction, where the rear cover 34 is inserted from the side on which the rear housing 32 opens to the outside of the motor 10, and the rear cover 34 closes the opening of the rear housing 32.

The drive shaft 12 passes through the front housing 30 in the axial direction to be exposed out of the front housing 30. The end of the drive shaft 12 on the side exposed from the front housing 30 is connected to the spindle 16 through the coupling 14. The drive shaft 12 passes through the rear cover 34 in the axial direction to be exposed out of the rear cover 34.

The front bearing 36 is disposed in a bearing accommodation portion 30a of the front housing 30, and the drive shaft 12 is pivotally supported by the front bearing 36. The rear bearing 38 is disposed in a bearing accommodation portion 34a of the rear cover 34, and the drive shaft 12 is pivotally supported by the rear bearing 38. The front bearing 36 and the rear bearing 38 are rolling ball bearings and capable of supporting radial and axial loads.

A load sensor 40 is provided between an axial-direction side surface of an outer race 36a of the front bearing 36 and the bearing accommodation portion 30a of the front housing 30. The type of the load sensor 40 is not particularly limited, which can be strain gauge resistance type, semiconductor piezoresistive type, capacitance type, or silicon resonant type, for example. The load sensor 40 acquires a load that axially acts on the outer race 36a of the front bearing 36. This load is a preload that is applied to the front bearing 36. The load sensor 40 constitutes a preload obtaining unit.

A disc spring 42 is provided between an axial-direction side surface of an outer race 38a of the rear bearing 38 and the bearing accommodation portion 34a of the rear cover 34. The disc spring 42 presses the outer race 38a of the rear bearing 38 to the side of the front bearing 36 so as to press the entirety of the drive shaft 12 to the side of the front bearing 36.

The end of the drive shaft 12 on the side pivotally supported by the front bearing 36 relative to its portion to which the rotor 26 is attached, is connected to the spindle 16 through the coupling 14.

### Configuration of Preload Judgement Device

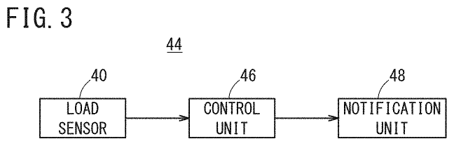

FIG. 3 is a block diagram showing the configuration of a preload judgement device 44. The preload judgement device 44 includes the load sensor 40, a control unit 46, and a notification unit 48.

The control unit 46 receives, as input, the preload on the front bearing 36 that is obtained by the load sensor 40. When the inputted preload is not in a set range, the control unit 46 causes the notification unit 48 to give notification indicating that the preload on the front bearing 36 is not within the set range. When the inputted preload is not in the set range, the control unit 46 notifies that the connection between the drive shaft 12 of the motor 10 and the spindle 16 by the coupling 14 is not made properly.

The notification unit 48 can be a speaker configured to give notification by sound, or a display configured to give notification by letters or image, for example. The notification unit 48 is controlled by the control unit 46 to give notification to an operator by sound, letters, image, or the like.

### Preload Judgement Process

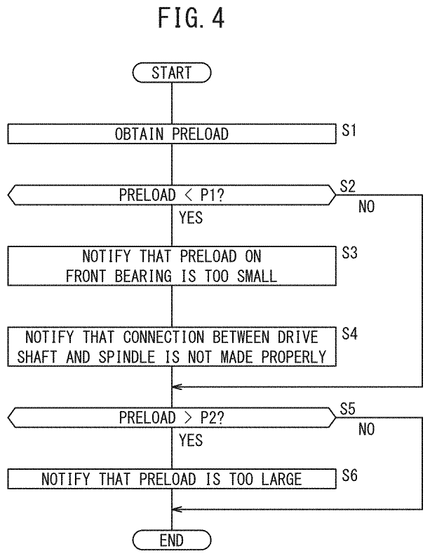

FIG. 4 is a flowchart showing the flow of a preload judgement process that is performed in the control unit 46.

At step S1, the control unit 46 obtains a preload on the front bearing 36. At step S2, the control unit 46 judges whether the preload is smaller than a set value P1. When the preload is smaller than the set value P1, the process moves to step S3. When the preload is equal to or larger than the set value P1, the process moves to step S5.

At step S3, the control unit 46 controls the notification unit 48 to give notification that the preload on the front bearing 36 is too small. Also, at step S3, the control unit 46 may control the notification unit 48 such that it also gives notification indicating that the preload on the rear bearing 38 is too large. At step S4, the control unit 46 controls the notification unit 48 so as to give notification indicating that the connection between the drive shaft 12 of the motor 10 and the spindle 16 is not made properly.

At step S5, the control unit 46 judges whether the preload is larger than a set value P2 (P2>P1). When the preload is larger than the set value P2, the process moves to step S6. When the preload is equal to or smaller than the set value P2, the process is terminated. At step S6, the control unit 46 controls the notification unit 48 to give notification indicating that the preload on the front bearing 36 is too large. Also, at step S6, the control unit 46 may control the notification unit 48 such that it also gives notification indicating that the preload on the rear bearing 38 is too small.

### Functions and Effects

When internal clearance exists in a rolling ball bearing, which is used as the front bearing 36 and the rear bearing 38 of this embodiment, then the balls have large play and the bearing has low rigidity, and then rotational vibration of the shaft is large. Accordingly, it is necessary to previously apply a load to the bearing in the axial direction to make the internal clearance zero. The load applied to the bearing in the axial direction is called a preload. Applying a preload reduces vibration of the bearing and improves its rigidity. However, if the preload is excessively large, it causes increased noise and shortens the life of the bearing.

In this embodiment, the disc spring 42 disposed between the rear bearing 38 and the rear cover 34 presses the rear bearing 38 to the side of the front bearing 36, thereby to press the entirety of the drive shaft 12 to the front bearing 36 side, in order that the preloads acting on the front bearing 36 and the rear bearing 38 become appropriate.

However, the preloads on the front bearing 36 and the rear bearing 38 may become too large or too small in the following situations. In this embodiment, the drive shaft 12 is connected to the spindle 16 by the coupling 14. The sliding resistance between the insertion hole 20a of the first hub 20 and the drive shaft 12 and the sliding resistance between the insertion hole 22a of the second hub 22 and the drive shaft 12 are relatively large. Therefore, if the spindle 16 is excessively pushed to the side of the motor 10, then the drive shaft 12 is pressed through the coupling 14, possibly causing the preload on the front bearing 36 to become too small and the preload on the rear bearing 38 to become too large.

Further, when the motor 10 is used in such a position that the front bearing 36 is on the upper side in the gravity direction and the rear bearing 38 is on the lower side in the gravity direction, then, due to the weights of the rotor 26 and the drive shaft 12, the preload on the front bearing 36 may become too small and the preload on the rear bearing 38 may become too large. On the other hand, when the motor 10 is used in such a position that the front bearing 36 is on the lower side in the gravity direction and the rear bearing 38 is on the upper side in the gravity direction, then, due to the weights of the rotor 26 and the drive shaft 12, the preload on the front bearing 36 may become too large and the preload on the rear bearing 38 may become too small.

An operator can judge whether the preloads acting on the front bearing 36 and the rear bearing 38 are appropriate by measuring the length of the portion of the drive shaft 12 that is exposed out of the rear cover 34. However, performing the measurement is troublesome work for the operator and requires some process steps.

Accordingly, in this embodiment, the load sensor 40 is provided between a side surface of the front bearing 36 in the rotary axis direction and the front housing 30 of the motor 10. When the preload on the front bearing 36 obtained by the load sensor 40 is not in a set range, the notification unit 48 notifies the operator of the information. This allows the operator to judge whether the preloads acting on the front bearing 36 and the rear bearing 38 are appropriate or not, without performing the measurement work.

Further, when the preload on the front bearing 36 obtained by the load sensor 40 is not in a set range, the notification unit 48 notifies the operator that the connection between the drive shaft 12 and the spindle 16 is not made properly. This allows the operator to judge whether the connection between the drive shaft 12 and the spindle 16 is made properly, without performing the measurement work.

Furthermore, in this embodiment, the load sensor 40 is disposed between a side surface in the axial direction of the outer race 36a of the front bearing 36 and the bearing accommodation portion 30a of the front housing 30 of the motor 10. The outer race 36a has some looseness with respect to the front housing 30, so that the load sensor 40 can highly accurately obtain the preload on the front bearing 36.

### Modifications

While the first embodiment employs the load sensor 40 as a preload obtaining unit for obtaining the preload on the front bearing 36, the preload of the front bearing 36 may be obtained by using a different sensor. For example, a displacement sensor may be employed which detects the position of the end of the drive shaft 12 on the rear cover 34 side, with respect to a reference position.

While, in the first embodiment, the drive shaft 12 of the motor 10 is connected to the spindle 16, the drive shaft 12 may be connected to a different rotating body.

Further, while in the first embodiment the load sensor 40 is disposed between a side surface of the front bearing 36 in the axial direction and the front housing 30, the load sensor 40 may be disposed between a side surface of the rear bearing 38 in the axial direction and the rear cover 34. In this case, the disc spring 42 is disposed between a side surface of the front bearing 36 in the axial direction and the front housing 30.

### Technical Ideas Obtained from Embodiments

Technical ideas that can be grasped from the embodiments described above will be recited below.

The preload judgement device (44) includes: the preload obtaining unit (40) configured to obtain a preload that acts on the bearing (36) that pivotally supports the drive shaft (12) of the motor (10); and the notification unit (48) configured to give notification that the preload is not appropriate when the obtained preload is not in a set range. This allows an operator to judge whether the preload acting on the bearing is appropriate without performing measurement work.

In the preload judgement device above, the preload obtaining unit may be the load sensor (40) disposed between a side surface of the bearing in a rotary axis direction and the housing (30) of the motor. The load sensor can directly measure the preload acting on the bearing and therefore the preload can be obtained highly accurately.

In the preload judgement device above, the load sensor may be disposed between the outer race (36a) of the bearing and the housing. The outer race has some looseness with respect to the housing of the motor, so that the load sensor can obtain the preload of the bearing highly accurately.

In the preload judgement device above, the spindle (16) of a machine tool may be connected to the drive shaft through the coupling (14). Then, the preload obtaining unit can obtain variation in the preload of the bearing when the drive shaft is pressed from the spindle through the coupling.

In the preload judgement device above, the notification unit may be further configured to give notification that the connection between the drive shaft and the spindle is not properly made when the obtained preload is not in the set range. This allows the operator to judge whether the connection between the drive shaft and the spindle is made properly without performing measurement work.

The preload judgement method includes: the preload obtaining step of obtaining a preload that acts on the bearing (36) that pivotally supports the drive shaft (12) of the motor (10); and a notification step of controlling a notification unit to give notification that the preload is not appropriate when the obtained preload is not in a set range. This allows the operator to judge whether the preload acting on the bearing is appropriate without performing measurement work.

In the preload judgement method above, the spindle (16) of a machine tool may be connected to the drive shaft through the coupling (14), and the notification step may control the notification unit so as to give notification that the connection between the drive shaft and the spindle is not properly made when the obtained preload is not in the set range. This allows the operator to judge whether the connection between the drive shaft and the spindle is made properly without performing measurement work.

The present invention is not limited to the embodiments described above, and it goes without saying that the embodiments can be freely modified within a range that does not deviate from the essence and gist of the present invention as set forth in the appended claims.

What is claimed is:

1. A preload judgement device comprising:
a preload obtaining unit configured to obtain a preload that acts on a bearing that pivotally supports a drive shaft of a motor; and
a notification unit configured to give notification that the preload is not appropriate when the obtained preload is not in a set range.

2. The preload judgement device according to claim 1, wherein the preload obtaining unit is a load sensor disposed between a side surface of the bearing in a rotary axis direction and a housing of the motor.

3. The preload judgement device according to claim 2, wherein the load sensor is disposed between an outer race of the bearing and the housing.

4. The preload judgement device according to claim 1, wherein a spindle of a machine tool is connected to the drive shaft through a coupling.

5. The preload judgement device according to claim 4, wherein the notification unit is further configured to give notification that the connection between the drive shaft and the spindle is not properly made when the obtained preload is not in the set range.

6. A preload judgement method comprising:
a preload obtaining step of obtaining a preload that acts on a bearing that pivotally supports a drive shaft of a motor; and
a notification step of controlling a notification unit to give notification that the preload is not appropriate when the obtained preload is not in a set range.

7. The preload judgement method according to claim 6,
wherein a spindle of a machine tool is connected to the drive shaft through a coupling, and
the notification step controls the notification unit so as to give notification that the connection between the drive shaft and the spindle is not properly made when the obtained preload is not in the set range.
